(19) United States
(12) Patent Application Publication
(10) Pub. No.: US 2021/0223442 A1
(43) Pub. Date: Jul. 22, 2021

(54) NEGATIVE OPTICAL POWER LIQUID LENS

(71) Applicant: CORNING INCORPORATED, CORNING, NY (US)

(72) Inventors: Joseph Marshall Kunick, Victor, NY (US); Shawn Michael O'Malley, Horseheads, NY (US)

(21) Appl. No.: 17/054,925

(22) PCT Filed: May 17, 2019
(86) PCT No.: PCT/US2019/032889

§ 371 Date: Nov. 12, 2020

Related U.S. Application Data
(60) Provisional application No. 62/674,511, filed on May 21, 2018.

(51) Int. Cl. G02B 3/14; G02B 26/00; C09K 9/02

(52) U.S. Cl. CPC G02B 3/14; C09K 2211/14; C09K 9/02; G02B 26/005

(57) ABSTRACT

A negative optical power electrowetting optical device is provided. The negative optical power electrowetting optical device includes: a non-conductive liquid having a refractive index; a conductive liquid having a second refractive index; and a dielectric surface in contact with both the conductive and non-conductive liquids. The refractive index of the non-conductive liquid is less than the second refractive index of the conductive liquid and wherein the conductive liquid is immiscible with the non-conductive liquid.

### CROSS-REFERENCE TO RELATED APPLICATIONS

This application claims the benefit of priority under 35 U.S.C. § 119 of U.S. Provisional Application No. 62/674,511, filed May 21, 2018, the content of which is incorporated herein by reference in its entirety.

### FIELD OF THE DISCLOSURE

The disclosure relates to liquid lenses and, more particularly, liquid lenses having a negative optical power using low refractive index hydrophobic liquids.

### BACKGROUND

Conventional electrowetting based liquid lenses are based on two immiscible liquids disposed within a chamber, namely an oil and a conductive phase, the latter being water based. The two liquid phases typically form a triple interface on an isolating substrate comprising a dielectric material. Varying an electric field applied to the liquids can vary the wettability of one of the liquids relative to walls of the chamber, which has the effect of varying the shape of a meniscus formed between the two liquids. Further, in various applications, changes to the shape of the meniscus result in changes to the focal length of the lens.

As liquid lenses expand into new and expanding application areas, it may be beneficial for the liquid formulations used in these devices to be enabled at a variety of different environmental conditions to quickly respond to voltages to provide, for example, autofocus and optical image stabilization capabilities. Among the drawbacks of using known liquid formulations, in particular the oil phase, is a high dispersion or variation in the index of refraction across a range of wavelengths. Finding an oil with a desired refractive index and a low chromatic dispersion can enable new and/or improved liquid lens applications.

Accordingly, there is a need for liquids used in liquid lens configurations to provide reduced chromatic aberrations for desired refractive indices, which can translate into improved liquid lens reliability, performance, and manufacturing cost.

### SUMMARY OF THE DISCLOSURE

According to some embodiments of the present disclosure, a negative optical power electrowetting optical device is provided. The negative optical power electrowetting optical device includes: a non-conductive liquid having a refractive index; a conductive liquid having a second refractive index; and a dielectric surface in contact with both the conductive and non-conductive liquids. The refractive index of the non-conductive liquid is less than the second refractive index of the conductive liquid and wherein the conductive liquid is immiscible with the non-conductive liquid.

According to some embodiments of the present disclosure, a liquid shutter is provided. The liquid shutter includes a negative optical power electrowetting optical device having: a non-conductive liquid having a refractive index; a conductive liquid having a second refractive index; and a dielectric surface in contact with both the conductive and non-conductive liquids. The liquid shutter additionally includes an imaging lens and a blocking member positioned between the negative optical power electrowetting optical device and the imaging lens. The refractive index of the non-conductive liquid is less than the second refractive index of the conductive liquid and wherein the conductive liquid is immiscible with the non-conductive liquid.

According to some embodiments of the present disclosure, a negative optical power liquid system is provided. The negative optical power liquid system includes a non-conductive liquid having a refractive index and a conductive liquid having a second refractive index. The refractive index of the non-conductive liquid is less than the second refractive index of the conductive liquid and wherein the conductive liquid is immiscible with the non-conductive liquid.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic cross-sectional view of an exemplary electrowetting optical device according to some embodiments of the present disclosure.

FIG. 2 is a schematic cross-sectional view of a conventional liquid lens providing a positive optical power.

FIG. 3 is a schematic cross-sectional view of a liquid lens providing a tilt interface according to some embodiments of the present disclosure.

FIG. 4 is a schematic cross-sectional view of a liquid lens providing a negative optical power according to some embodiments of the present disclosure.

FIG. 5 is a plot of the chromatic aberrations for positive and negative optical power liquid lenses according to some embodiments of the present disclosure.

FIGS. 6A-6C are schematic cross-sectional views of a liquid shutter according to some embodiments of the present disclosure.

FIGS. 7A-7B are schematic cross-sectional views of a liquid lens positioned with optics positioned in a mobile phone camera module according to some embodiments of the present disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “non-miscible” and “immiscible” refer to liquids that do not form a homogeneous mixture when added together or minimally mix when the one liquid is added into the other. In the present description and in the following claims, two liquids are considered non-miscible when their partial miscibility is below 2%, below 1%, below 0.5%, or below 0.2%, all values being measured within a given temperature range, for example at 20° C. The liquids herein have a low mutual miscibility over a broad temperature range including, for example, −30° C. to 85° C. and from −20° C. to 65° C.

The term “conductive liquid”, as used herein means a liquid having a conductivity from about 1×10⁻³ S/m to about 1×10² S/m, from about 0.1 S/m to about 10 S/m, or from about 0.1 S/m to about 1 S/m. The term “non-conductive liquid”, as used herein means a liquid having little to no measureable conductivity including, for example, a conductivity less than about 1×10⁻⁸ S/m, less than about 1×10¹⁰ S/m, or less than about 1×10¹⁴ S/m.

The refractive index values reported herein are reported as measured at a wavelength of 589 nm unless otherwise noted.

In various embodiments, a negative optical power electrowetting optical device is provided. The negative optical power electrowetting optical device includes a non-conductive liquid having a refractive index; a conductive liquid having a second refractive index; and a dielectric surface in contact with both the conductive and non-conductive liquids. The refractive index of the non-conductive liquid is less than the second refractive index of the conductive liquid and wherein the conductive liquid is immiscible with the non-conductive liquid.

The “non-conductive liquid” described here can be a low refractive index, low chromatic dispersion, non-polar, non-conductive liquid used as the active element in a liquid electrowetting optical device having a negative optical power. This low index, low chromatic dispersion, non-polar, non-conductive liquid is used herein to replace high index, high dispersion liquids typically used in positive optical power liquid lenses to form a negative liquid lens instead. The use of a negative power liquid lens or negative optical power electrowetting optical device described herein are important because they have no mechanical parts but rather use electrowetting to actuate the lens as a focusing optic. These electrowetting devices use a two liquid system wherein one liquid acts as a light directing element while the second liquid acts to support the light directing element. The light directing liquid is typically an oil based liquid while the second liquid is an antifreeze liquid that is typically electrically conductive and polar. In conventional liquid lenses, the oil has a higher refractive index than the polar liquid in order to make a positive lens. By designing and selecting non-conductive liquids that possess refractive indices lower than the refractive indices of the respective conductive liquids, negative optical power electrowetting devices or negative power liquid lenses can be made.

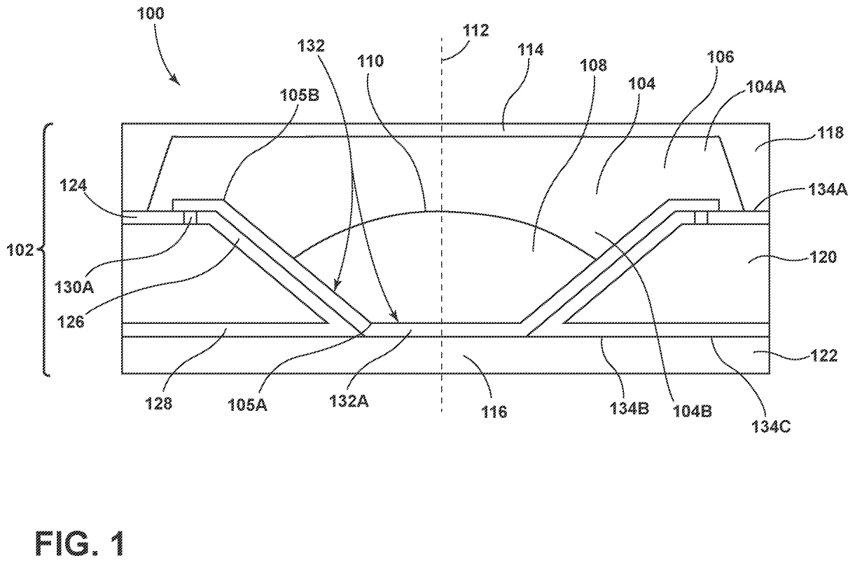

As described in more detail below in FIG. 1, a cell of an electrowetting optical device or liquid lens is generally defined by two transparent insulating plates and side walls. The lower plate, which is non-planar, comprises a conical or cylindrical depression or recess, which contains a non-conductive or insulating liquid. The remainder of the cell is filled with an electrically conductive liquid, non-miscible with the insulating liquid, having a different refractive index and substantially the same density. One or more driving electrodes are positioned on the side wall of the recess. An insulating thin layer may be introduced between the driving electrode(s) and the respective liquids to provide an electrowetting on the dielectric surface having long term chemical stability. A common electrode is in contact with the conductive liquid. Through electrowetting phenomena, it is possible to modify the curvature of the interface between the two liquids, according to the voltage V applied between the electrodes. Thus, a beam of light passing through the cell normal to the plates in the region of the drop will be defocused to a greater or lesser extent according to the voltage applied. The conductive liquid generally is an aqueous liquid containing salts. The non-conductive liquid is typically an oil, an alkane or a mixture of alkanes, possibly halogenated.

In some embodiments, the voltage differential between the voltage at the common electrode and the voltage at the driving electrode can be adjusted. The voltage differential can be controlled and adjusted to move an interface between the liquids (i.e., a meniscus) to a desired position along the sidewalls of the cavity. By moving the interface along sidewalls of the cavity, it is possible to change the focus (e.g., diopters), tilt, astigmatism, and/or higher order aberrations of the liquid lens.

### Liquid Lens Structure

Referring now to FIG. 1, a simplified cross-sectional view of an exemplary liquid lens 100 is provided. The structure of the liquid lens 100 is not meant to be limiting and may include any structure known in the art. In some embodiments, the liquid lens 100 may comprise a lens body 102 and a cavity 104 formed in the lens body 102. A first liquid 106 and a second liquid 108 may be disposed within cavity 104. In some embodiments, first liquid 106 may be a polar liquid, also referred to as the conducting liquid. Additionally, or alternatively, second liquid 108 may be a non-polar liquid and/or an insulating liquid, also referred to as the non-conducting liquid. In some embodiments, an interface 110 between first liquid 106 and second liquid 108 forms a lens. For example, first liquid 106 and second liquid 108 may be immiscible with each other and have different refractive indices such that interface 110 between the first liquid and the second liquid forms a lens. In some embodiments, first liquid 106 and second liquid 108 may have substantially the same density, which can help to avoid changes in the shape of interface 110 as a result of changing the physical orientation of liquid lens 100 (e.g., as a result of gravitational forces).

In some embodiments of the liquid lens 100 depicted in FIG. 1, cavity 104 may comprise a first portion, or headspace, 104A and a second portion, or base portion, 104B. For example, second portion 104B of cavity 104 may be defined by a bore in an intermediate layer of liquid lens 100 as described herein. Additionally, or alternatively, first portion 104A of cavity 104 may be defined by a recess in a first outer layer of liquid lens 100 and/or disposed outside of the bore in the intermediate layer as described herein. In some embodiments, at least a portion of first liquid 106 may be disposed in first portion 104A of cavity 104. Additionally, or alternatively, second liquid 108 may be disposed within second portion 104B of cavity 104. For example, substantially all or a portion of second liquid 108 may be disposed within second portion 104B of cavity 104. In some embodiments, the perimeter of interface 110 (e.g., the edge of the interface in contact with the sidewall of the cavity) may be disposed within second portion 104B of cavity 104.

Interface 110 of the liquid lens 100 (see FIG. 1) can be adjusted via electrowetting. For example, a voltage can be applied between first liquid 106 and a surface of cavity 104 (e.g., one or more driving electrode(s) positioned near the surface of the cavity 104 and insulated from the first liquid 106 as described herein) to increase or decrease the wettability of the surface of the cavity 104 with respect to the first liquid 106 and change the shape of interface 110. In some embodiments, adjusting interface 110 may change the shape of the interface 110, which changes the focal length or focus of liquid lens 100. For example, such a change of focal length can enable liquid lens 100 to perform an autofocus function. Additionally, or alternatively, adjusting interface 110 may tilt the interface relative to an optical axis 112 of liquid lens 100. For example, such tilting can enable liquid lens 100 to perform an optical image stabilization (OIS) function in addition to providing astigmatism variations or higher order optical aberration corrections. Adjusting interface 110 may be achieved without physical movement of liquid lens 100 relative to an image sensor, a fixed lens or lens stack, a housing, or other components of a camera module in which the liquid lens 100 can be incorporated.

In some embodiments, lens body 102 of liquid lens 100 may comprise a first window 114 and a second window 116. In some of such embodiments, cavity 104 may be disposed between first window 114 and second window 116. In some embodiments, lens body 102 may comprise a plurality of layers that cooperatively form the lens body 102. For example, in the embodiments shown in FIG. 1, lens body 102 may comprise a first outer layer 118, an intermediate layer 120, and a second outer layer 122. In some of such embodiments, intermediate layer 120 may comprise a bore formed therethrough. First outer layer 118 may be bonded to one side (e.g., the object side) of intermediate layer 120. For example, first outer layer 118 may be bonded to intermediate layer 120 at a bond 134A. Bond 134A may be an adhesive bond, a laser bond (e.g., a laser weld), a mechanical closing, or any another suitable bond capable of maintaining first liquid 106 and second liquid 108 within cavity 104. Additionally, or alternatively, second outer layer 122 may be bonded to the other side (e.g., the image side) of intermediate layer 120. For example, second outer layer 122 may be bonded to intermediate layer 120 at a bond 134B and/or a bond 134C, each of which can be configured as described herein with respect to bond 134A. In some embodiments, intermediate layer 120 may be disposed between first outer layer 118 and second outer layer 122, the bore in the intermediate layer may be covered on opposing sides by the first outer layer 118 and the second outer layer 122, and at least a portion of cavity 104 may be defined within the bore. Thus, a portion of first outer layer 118 covering cavity 104 may serve as first window 114, and a portion of second outer layer 122 covering the cavity may serve as second window 116.

In some embodiments, cavity 104 may comprise first portion 104A and second portion 104B. For example, in the embodiments shown in FIG. 1, second portion 104B of cavity 104 may be defined by the bore in intermediate layer 120, and first portion 104A of the cavity may be disposed between the second portion 104B of the cavity 104 and first window 114. In some embodiments, first outer layer 118 may comprise a recess as shown in FIG. 1, and first portion 104A of cavity 104 may be disposed within the recess in the first outer layer 118. Thus, first portion 104A of cavity 104 may be disposed outside of the bore in intermediate layer 120.

In some embodiments, cavity 104 (e.g., second portion 104B of the cavity 104) may be tapered as shown in FIG. 1 such that a cross-sectional area of the cavity 104 decreases along optical axis 112 in a direction from the object side to the image side. For example, second portion 104B of cavity 104 may comprises a narrow end 105A and a wide end 105B. The terms “narrow” and “wide” are relative terms, meaning the narrow end 105A is narrower than the wide end 105B. Such a tapered cavity can help to maintain alignment of interface 110 between first liquid 106 and second liquid 108 along optical axis 112. In other embodiments, the cavity 104 is tapered such that the cross-sectional area of the cavity 104 increases along the optical axis in the direction from the object side to the image side or non-tapered such that the cross-sectional area of the cavity 104 remains substantially constant along the optical axis.

In some embodiments, image light may enter the liquid lens 100 depicted in FIG. 1 through first window 114, may be refracted at interface 110 between first liquid 106 and second liquid 108, and may exit the liquid lens 100 through second window 116. In some embodiments, first outer layer 118 and/or second outer layer 122 may comprise a sufficient transparency to enable passage of the image light. For example, first outer layer 118 and/or second outer layer 122 may comprise a polymeric, glass, ceramic, or glass-ceramic material. In some embodiments, outer surfaces of first outer layer 118 and/or second outer layer 122 may be substantially planar. Thus, even though liquid lens 100 can function as a lens (e.g., by refracting image light passing through interface 110), outer surfaces of the liquid lens 100 can be flat as opposed to being curved like the outer surfaces of a fixed lens. In other embodiments, outer surfaces of the first outer layer 118 and/or the second outer layer 122 may be curved (e.g., concave or convex). Thus, the liquid lens 100 may comprise an integrated fixed lens. In some embodiments, intermediate layer 120 may comprise a metallic, polymeric, glass, ceramic, or glass-ceramic material. Because image light can pass through the bore in intermediate layer 120, the intermediate layer 120 may or may not be transparent.

In some embodiments, liquid lens 100 (see FIG. 1) may comprise a common electrode 124 in electrical communication with first liquid 106. Additionally, or alternatively, liquid lens 100 may comprise a/or several driving electrode(s) 126 disposed on a sidewall of cavity 104 and insulated from first liquid 106 and second liquid 108. Different voltages can be supplied to common electrode 124 and driving electrode(s) 126 to change the shape of interface 110 as described herein.

In some embodiments, liquid lens 100 (see FIG. 1) may comprise a conductive layer 128 at least a portion of which is disposed within cavity 104. For example, conductive layer 128 may comprise a conductive coating applied to intermediate layer 120 prior to bonding first outer layer 118 and/or second outer layer 122 to the intermediate layer. Conductive layer 128 may comprise a metallic material, a conductive polymer material, another suitable conductive material, or a combination thereof. Additionally, or alternatively, conductive layer 128 may comprise a single layer or a plurality of layers, some or all of which can be conductive. In some embodiments, conductive layer 128 may define common electrode 124 and/or driving electrode(s) 126. For example, conductive layer 128 may be applied to substantially the entire outer surface of intermediate layer 118 prior to bonding first outer layer 118 and/or second outer layer 122 to the intermediate layer. Following application of conductive layer 128 to intermediate layer 118, the conductive layer may be segmented into various conductive elements (e.g., common electrode 124 and/or driving electrode 126). In some embodiments, liquid lens 100 may comprise a scribe 130A in conductive layer 128 to isolate (e.g., electrically isolate) common electrode 124 and driving electrode 126 from each other. In some embodiments, scribe 130A may comprise a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

As also depicted in FIG. 1, the liquid lens 100 may comprise an insulating layer 132 disposed within cavity 104, on top on the driving electrode layer. For example, insulating element 132 may comprise an insulating coating applied to intermediate layer 120 prior to bonding first outer layer 118 and/or second outer layer 122 to the intermediate layer. In some embodiments, insulating element 132 may comprise an insulating coating applied to conductive layer 128 and second window 116 after bonding second outer layer 122 to intermediate layer 120 and prior to bonding first outer layer 118 to the intermediate layer. Thus, the insulating element 132 may cover at least a portion of conductive layer 128 within cavity 104 and second window 116. In some embodiments, insulating element 132 may be sufficiently transparent to enable passage of image light through second window 116 as described herein.

In some embodiments of the liquid lens 100 depicted in FIG. 1, the insulating element 132 may cover at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 may be uncovered by insulating element 132. Thus, common electrode 124 may be in electrical communication with first liquid 106 as described herein.

In some embodiments, insulating element 132 may comprise a hydrophobic surface layer of second portion 104B of cavity 104. Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein.

To provide a wide range of focal distances, tilt angles, and/or astigmatism variations, a significant difference in the optical index between the conductive and non-conductive liquids is beneficial. By replacing the high refractive index, non-polar liquids used in conventional liquid lenses with a low refractive index and low dispersion liquid, a decrease in the chromatic aberration can be achieved which can provide improved image quality in camera devices that include a liquid lens in the optical train for autofocus and optical image stabilization. The refractive index may be lower, typically >0.08 or more, than the polar liquid index to create significant optical power. Since the index of refraction is lower, however, the interface now provides negative optical power. This negative optical power creates opportunities for operation not available to positive liquid lenses. Examples include use as a shutter or reflective display or to image virtual objects. The description and corresponding material properties for these two respective liquids is provided below.

### Conductive Liquid

The conductive liquids used to make the negative optical power electrowetting device can be varied to provide second refractive indices higher than the refractive indices of the non-conducting liquid. In some embodiments, the second refractive index of the conductive liquid is greater than 1.40, is greater than 1.42, is greater than 1.44, is greater than 1.46, is greater than 1.48, or is greater than 1.50. In some embodiments, the conductive liquids can be formulated and/or selected to have higher refractive index values than the non-conductive liquid while the conductive liquid can be additionally adjusted to match the other properties of the low refractive index conductive liquids such as viscosity and temperature. For example, in some embodiments, mono propylene glycol (MPG) and/or ethylene glycol can be adjusted to meet viscosity requirements while salt additives such as LiBr can be added to elevate the refractive index as required for the desired application. In some embodiments, the refractive index of the conductive liquid may be increased by adding a water-soluble germanium compound including, for example, germanium salts or organic germanium compounds.

In some embodiments, the conductive liquid may be an aqueous solution. In other embodiments, the conductive liquid may include no water. In some embodiments, the conductive liquid may include from about 0.01% w/w to about 100% w/w, from about 0.1% w/w to about 50% w/w, from about 0.1% w/w to about 25% w/w, from about 0.1% w/w to about 15% w/w, from about 1% w/w to about 10% w/w, or from about 1% w/w to about 5% w/w of water, based on the total weight of the conductive liquid. In some embodiments, the conductive liquid may include from about 0.01% w/w to about 100% w/w, from about 1% w/w to about 100% w/w, from about 1% w/w to about 50% w/w, from about 50% w/w to about 100% w/w, from about 75% w/w to about 95% w/w, or from about 2% w/w to about 25 w/w of a salt, based on the total weight of the conductive liquid. In some embodiments, the water and/or polar solvent may be mixed with one or more different salts including either organic and/or inorganic salts. The term, “ionic salts”, as referred to herein, refers to salts that are totally or substantially dissociated in water (such as an acetate-anion and a cation). Likewise, the term, “ionizable salts”, as referred to herein, refers to salts that are totally or substantially dissociated in water, after chemical, physical or physico-chemical treatment. Examples of anions used in these types of salts include, but are not limited to, halides, sulfate, carbonate, hydrogen carbonate, acetate, 2-fluoracetate, 2,2-difluoroacetate, 2,2,2-trifluoroacetate, 2,2,3,3,3-pentafluoropropanoate, triflate, fluoride, hexafluorophosphate, trifluoromethanesulfonate, and mixtures thereof. Examples of cations used in these types of salts include, but are not limited to, alkali/alkaline earth and metallic cations e.g. sodium, magnesium, potassium, lithium, calcium, zinc, fluorinated ammonium, e.g. N-(fluoromethyl)-2-hydroxy-N,N-dimethyl-ethanaminium, and mixtures thereof. In some embodiments, any combination of the above-referenced anions and cations may be used in the conductive liquid.

In some embodiments, at least one organic and/or inorganic ionic or ionizable salt is used to confer conductive properties to the water and decrease the freezing point of the mixed liquid. In some embodiments, the ionic salts may include, for example, sodium sulfate, potassium acetate, sodium acetate, zinc bromide, sodium bromide, lithium bromide, and combinations thereof. In other embodiments, the ionic salt may include fluorinated salts including fluorinated organic ionic salts. In some embodiments, the organic and inorganic ionic and ionizable salts may include, but are not limited to, potassium acetate, magnesium chloride, zinc bromide, lithium bromide, lithium chloride, calcium chloride, sodium sulfate, sodium triflate, sodium acetate, sodium trifluoroacetate and the like, as well as mixtures thereof.

Fluorinated salts, including fluorinated organic ionic salts, can advantageously maintain a relatively low refractive index of the conductive liquid while facilitating changes of the physical properties of the conductive liquid, such as lowering the freezing point of the conductive liquid. Fluorinated salts, unlike traditional chloride salts, may also demonstrate reduced corrosion with the materials constituting the cell of the electrowetting optical device, e.g. the steel, stainless steel, or brass components.

The water used in the conductive liquid is preferred to be as pure as possible, i.e. free, or substantially free, of any other undesired dissolved components that could alter the optical properties of the electrowetting optical device. In some embodiments, ultrapure water (UPW) having a conductivity of about 0.055 μS/cm at 25° C. or a resistivity of 18.2 MOhm is used to form the conductive liquid.

In some embodiments, the conductive liquid may include an anti-freezing agent or freezing-point lowering agent. The use of anti-freezing agents such as salts, alcohols, diols, and/or glycols allows the conductive liquid to remain in a liquid state within a temperature range from about −30° C. to about +85° C., from about −20° C. to about +65° C., or from about −10° C. to about +65° C. In some embodiments, the use of the alcohol and/or glycol additives in the conductive and/or non-conductive liquids can help provide a steady interface tension between the two liquids over a broad range of temperature. Depending on the desired application and properties desired from the conductive liquid and resultant liquid lens, the conductive liquid may include less than about 95% by weight, less than about 90% by weight, less than about 80% by weight, less than about 70% by weight, less than about 60% by weight, less than about 50% by weight, less than about 40% by weight, less than about 30% by weight, less than about 20% by weight, less than about 10% by weight, or less than about 5% by weight anti-freezing agent. In some embodiments, the conductive liquid may include more than about 95% by weight, more than about 90% by weight, more than about 80% by weight, more than about 70% by weight, more than about 60% by weight, more than about 50% by weight, more than about 40% by weight, more than about 30% by weight, more than about 20% by weight, more than about 10% by weight, or more than about 5% by weight anti-freezing agent. In some embodiments, the anti-freezing agent may be a glycol including, for example, monopropylene glycol, ethylene glycol, 1,3-propanediol (trimethylene glycol or TMG), glycerol, dipropylene glycol, and combinations thereof. In some embodiments using glycols, the glycol may have a weight average molecular weight (Mw) from 200 g/mol to 2000 g/mol, from 200 g/mol to 1000 g/mol, from 350 g/mol to 600 g/mol, from 350 g/mol to 500 g/mol, from 375 g/mol to 500 g/mol, or a mixture thereof. In some embodiments, the glycol may be a dimer, trimer, tetramer, or any combination from 2 to 100 monomer diol or triol units including all integers in between.

In some embodiments, the conductive liquid may include at least one viscosity-controlling agent, namely a viscosity-adjusting agent. The viscosity-adjusting agent may include any compound or mixture known in the art and may include, for example, an alcohol, a glycol, a glycol ether, a polyol, a poly ether polyol and the like, or mixtures thereof. In some embodiments, the viscosity-adjusting agent may include, for example, ethanol, ethylene glycol (EG), monopropylene glycol (MPG), 1,3-propane diol, 1,2,3-propane triol (glycerol), and mixtures thereof. In some embodiments, the viscosity-adjusting agent has a molecular weight of less than about 130 g/mol. In some embodiments, the same or different alcohols, diols, and/or glycols may be used as the anti-freezing agent or viscosity-controlling agent, respectfully.

In some embodiments, the conductive liquid may include a biocide agent to prevent the development of organic elements, such as bacteria, fungi, algae, micro-algae, and the like, which could worsen the optical properties of the optical electrowetting device, particularly in the case of the lens driven by electrowetting. The biocide agent should not alter or minimally alter the required optical properties of the conductive liquid (e.g. transparency and refractive index). Biocide compounds include those known in the art and may include, for example, 2-methyl-4-isothiazoline-3-one (MIT) and 1,2-benzisothiozoline-3-one (BIT).

### Non-Conductive Liquid

The non-conductive liquids used to make the negative optical power electrowetting optical device disclosed herein may have refractive indices less than 1.40, less than 1.39, less than 1.38, less than 1.37, less than 1.36, less than 1.35, less than 1.34, less than 1.33, less than 1.32, less than 1.31, or less than 1.30. In some embodiments, the refractive index of the non-conductive liquid is less than 1.40. The refractive index of the non-conductive liquid may be at least 0.06 less, at least 0.07 less, at least 0.08 less, at least 0.09 less, at least 0.1 less, at least 0.11 less, at least 0.12 less, at least 0.13 less, at least 0.14 less, or at least 0.15 less than the second refractive index of the conductive liquid. In some embodiments, the refractive index of the non-conductive liquid is at least 0.08 less than the second refractive index of the conductive liquid. In other embodiments, the refractive index of the non-conductive liquid is at least 0.1 less than the second refractive index of the conductive liquid. In some embodiments, the non-conductive liquids can have lower refractive index values than the conductive liquid while the non-conductive liquid can be additionally adjusted to match the other physical properties of the higher second refractive index conductive liquids such as viscosity and density for a given temperature or temperature range.

In some embodiments, the non-conductive liquid includes an alkyl group having from 5 to about 40 carbon atoms, a fluorinated alkyl group having from 5 to about 40 carbon atoms, a silicone oil, a fluorinated silicone oil, a silane, a fluorinated silane, a perfluoropolyether (PFPE), a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof. In other embodiments, the non-conductive liquid includes a straight chain alkyl group having from 5 to about 20 carbon atoms, a branched alkyl group having from 5 to about 20 carbon atoms, a straight chain fluorinated alkyl group having from 5 to about 20 carbon atoms, a branched chain fluorinated alkyl group having from 5 to about 20 carbon atoms, a silicone oil, a fluorinated silicone oil, a silane, a fluorinated silane, a perfluoropolyether (PFPE), a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof.

As used herein, “alkyl” groups include straight chain and branched alkyl groups having from 5 to about 40 carbon atoms, and in some embodiments from 5 to about 20 carbon atoms or, in other embodiments, from 5 to about 12 carbon atoms. As employed herein, “alkyl groups” may include cycloalkyl groups as defined below. Alkyl groups may be substituted or unsubstituted. Examples of straight chain alkyl groups include n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. In some embodiments, the alkyl groups may be substituted one or more times with, for example, cyano, alkoxy, and fluorine groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

In some embodiments, silicone and fluorinated silicone based oils can be used to provide non-conductive liquids having refractive indices less than 1.4. Exemplary silicone oils having refractive indices less than 1.4 include those sold under the trade names Rhodorsil® Oils 47 (Bluestar Silicones). Both the silicone and fluorinated silicone oils can have their viscosity and refractive indices varied by controlling their degree of polymerization to modify their number and weight average molecular weights. The oils have a basic chemical structure as shown below and are designed according to chain length. In some embodiments, the non-conductive liquid comprises a silicone oil compound having Formula (I) and/or a fluorinated silicone oil compound having the Formula (II):

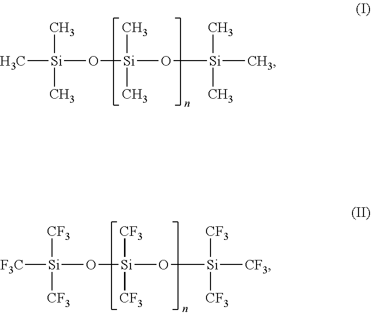

wherein n is 0 or an integer greater than 0.

In some embodiments, perfluoropolyether compounds can be used to provide non-conductive liquids having refractive indices less than 1.4. Exemplary perfluoropolyether compounds having refractive indices less than 1.4 include those sold under the trade names Galden® HT PFPE (Solvay). Perfluoropolyether compounds provide another class of non-conductive liquids having a broad range of viscosity values and densities for matching and blending with other non-conductive liquids to selectively match the physical properties of the conductive liquids. In some embodiments, the non-conductive liquid comprises a perfluoropolyether compound having Formula (III):

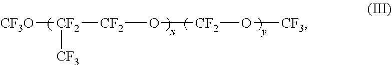

wherein x and y are individually an integer greater than 0. In some embodiments, x ranges from about 50 to about 500,000, from about 50 to about 50,000, from about 50 to about 5,000, or from about 50 to about 500. In some embodiments, y ranges from about 50 to about 500,000, from about 50 to about 50,000, from about 50 to about 5,000, or from about 50 to about 500.

In some embodiments, fluorinated aliphatic compounds can be used to provide non-conductive liquids having refractive indices less than 1.4. Exemplary fluorinated aliphatic compounds having refractive indices from 1.238 to 1.303 include those sold under the trade names FLUORINERT™ (by 3M™). The FLUORINERT™ family includes: FC-87, FC-72, FC-84, FC-77, FC-3255, FC-3283, FC-40, FC-43, FC-70, and FC-5312 where this series' kinematic viscosity (cs) ranges from as low as 0.4 to as high as 14.0 cs. Fluorinated aliphatic compounds provide another class of non-conductive liquids having a broad range of viscosity values and densities for matching and blending with other non-conductive liquids to selectively match the physical properties of the conductive liquids. The fluorinated aliphatic compounds represent another class of non-conductive-liquids that are suitable for forming the negative lens portion of a liquid lens.

In some embodiments, silanes and silane oligomers, including those sold under the trade names DYNASYLAN® (by EVONIK) provide another class of chemicals which can be sufficiently hydrophobic and have refractive indices less than 1.4. Silanes and silane oligomers provide another class of non-conductive liquids having a broad range of viscosity values and densities for matching and blending with other non-conductive liquids to selectively match the physical properties of the conductive liquids. In some embodiments, the non-conductive liquid includes a fluorinated silane compound. In some embodiments, the fluorinated silane compound is trichloro(1H,1H,2H,2H-perfluorooctyl)silane (FOTS) as provided below in Formula (IV). In some embodiments, the non-conductive liquid comprises a fluorinated silane compound having Formula (IV):

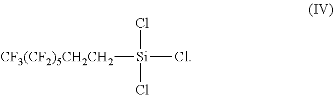

The non-conductive liquid disclosed herein may include one or more low index compounds including an alkyl group having from 5 to about 40 carbon atoms, a fluorinated alkyl group having from 5 to about 40 carbon atoms, a silicone oil, a fluorinated silicone oil, a silane, a fluorinated silane, a perfluoropolyether (PFPE), a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof. Depending on the desired application and corresponding properties of the non-conductive liquid, the non-conductive liquid may include from about 50 w/w to about 100% w/w low index compounds. In some embodiments, the non-conductive liquid may include from about 50% w/w to about 100% w/w, about 50% w/w to about 95% w/w, from about 5% w/w to about 95% w/w, or from about 25% w/w to about 75% w/w of any one or more of the low index compounds. In some embodiments, additional non-reactive compounds (e.g. oils, high or low viscosity liquids, oil soluble solids, etc.) may be respectively added to the non-conductive liquid to modify the refractive index and electrical properties of the formulated non-conductive liquid.

The non-conductive liquids and corresponding low index compounds disclosed herein can beneficially provide improved performance at a variety of temperature ranges that are beneficial to liquid lens/electrowetting optical devices, specifically those devices used across a wide range of temperatures. Improved performance at higher temperatures includes temperatures greater than 45° C., greater than 50° C., greater than 55° C., greater than 60° C., greater than 65° C., greater than 70° C., greater than 75° C., greater than 80° C. The non-conductive liquids and corresponding low index compounds described herein help to enable improved transmission recovery times of liquid lens/electrowetting optical devices.

In some embodiments, the non-conductive liquid may additionally include an organic or an inorganic (mineral) compound or mixture thereof. Examples of such organic or inorganic compounds include a hydrocarbon, a Si-based monomer or oligomer, a Ge-based monomer or oligomer, a Si—Ge-based monomer or oligomer, a high index polyphenylether compound, a low index fluorinated or perfluorinated hydrocarbon, or mixtures thereof. In some embodiments, the organic and/or inorganic compounds of the non-conductive liquid may include hexamethyldisilane, diphenyldimethylsilane, chlorophenyltrimethylsilane, phenyltrimethyl-silane, phenyltris(trimethylsiloxy)silane, polydimethylsiloxane, tetra-phenyltetramethyltrisiloxane, poly(3,3,3-trifluoropropylmethylsiloxane), 3,5,7-triphenylnonamethyl-pentasiloxane, 3,5-diphenyloctamethyltetrasiloxane, 1,1,5,5-tetraphenyl-1,3,3,5-tetramethyl-trisiloxane, hexamethylcyclotrisiloxane, hexamethyldigermane, diphenyldimethylgermane, phenyltrimethyl-germane. In some embodiments, the organic and/or inorganic compounds of the non-conductive liquid may include hexamethyldigermane, diphenyldimethylgermane, hexaethyldigermane, parrafin, or combinations thereof. For example, the paraffin oil ISOPAR® P includes a mixture of hydrocarbons produced and made commercially available by Exxon Mobil.

It has been discovered that the low refractive index non-conductive liquids (oils) disclosed herein that are used in negative optical power liquid lens/electrowetting optical applications can provide a wide range of focal distances, tilt angles, and/or astigmatism variations. In order to accomplish these benefits, the non-conductive liquid should meet at least one or more of the following properties: 1) a significantly lower refractive index as compared to the conductive liquids; 2) a density matched or similar to the conductive liquid over the operating temperature range of the liquid lens; 3) a low miscibility with the conductive liquid over the operating temperature range of the liquid lens; 4) chemical stability with respect to each of the non-conductive liquid's components and the nucleophilic water based electrolyte (conductive liquid); and 5) an adequate viscosity to match or achieve the desired response time for the liquid lens. The use of the materials as disclosed herein can enable a new combination of liquid materials used in non-conductive liquids/fluids that meet each of the five criteria mentioned above while being able to maintain these properties in the liquid lens/electrowetting optical device across a wide range of temperatures in a static and/or changing environment.

In consideration of the above criteria, the non-conducting and conducting liquids used in the negative optical power electrowetting optical device are designed such that they are not miscible when combined together and these liquids are formulated in order to closely match the viscosity and density of each other. The viscosity of each liquid can also be carefully matched, especially with regard to temperature ranges. Additionally, refractive index can change as a function of wavelength and here again a close matching for this attribute can also to be taken into account. In some embodiments, the combination of the non-conducting and conducting liquids can enable reduced intrinsic visible light absorbance. Accordingly, a range of different liquid systems, compositions, or mixtures as defined herein can be utilized to meet the requirements listed above with particular attention on the non-conductive liquid having a refractive index that is less than the second refractive index of the conductive liquid. In some embodiments, the non-conductive liquid is an oil while the conductive polar liquid is a salt containing antifreeze liquid, frequently water. In some embodiments, in order for the non-conductive liquid component (material part of lens that modifies the incident beam to achieve a desired focus) to have a low refractive index of less than 1.4, the non-conductive liquid can contain fluorine atoms. In some embodiments, the difference between the refractive index of the non-conductive liquid and the conductive liquid is about 0.1. In some embodiments, the conductive liquids may be doped with salts to improve their conductivity while in other embodiments the salts may act as freezing point depressing agents giving the salt a dual purpose.

With regard to the refractive index parameter, in some embodiments the non-conductive liquid may have a refractive index less than 1.40, less than 1.39, less than 1.38, less than 1.37, less than 1.36, less than 1.35, less than 1.34, less than 1.33, less than 1.32, less than 1.31, or less than 1.30. In other embodiments, the non-conductive liquid may have a refractive index of about 1.40, about 1.39, about 1.38, about 1.37, about 1.36, about 1.35, about 1.34, about 1.33, about 1.32, about 1.31, or about 1.30. In some embodiments, the difference in refractive index (Δη) between the conductive liquid and the non-conductive liquid may range from about 0.04 to about 0.2 or from about 0.08 to about 0.15. This optical index range for optical applications includes features such as variable focus, tilt, astigmatism compensations, and desired refractive index to balance precision versus range. In some embodiments, the Δη between the conductive liquid and the non-conductive liquid may be greater than 0.08, greater than 0.10, greater than 0.15, greater than 0.20, or greater than 0.25. The higher difference in refractive indices between the two liquids is well suited for optical applications including features such as zoom, variable focus or tilt devices, variable illumination devices wherein the illumination depends on the difference of refractive index between two liquids, and/or optical devices where a tilt of the optical axis can be performed, for example used for light beam deflection or image stabilization applications.

With regard to the density parameter, substantially matching the density of the non-conductive liquid with the density of the conductive liquid can help contribute to a versatile liquid lens/electrowetting optical device having a wide range of focal distances at a variety of tilt angles. In some embodiments, the difference in densities (Δρ) between the non-conductive liquid and conductive liquid may be lower than 0.1 g/cm³, lower than 0.01 g/cm³, or lower than 3.10⁻³ g/cm³ over a broad temperature range including from about −30° C. to about 85° C. or from about −20° C. to about 65° C.

With regards to the miscibility parameter, the disclosed conductive and non-conductive liquids are considered non-miscible. In some embodiments, the partial miscibility of the conductive and non-conductive liquids may be below 2%, below 1%, below 0.5%, or below 0.2%, where each of these values may be measured over a broad temperature range including, for example, −30° C. to 85° C. or from −20° C. to 65° C.

With regards to the stability parameter, the non-conductive liquid remains in the liquid state within a temperature range from about −10° C. to about +65° C., from about −20° C. to about +65° C., or from about −30° C. to about +85° C. In addition, the non-conductive liquid may not show any detectable signs of decomposition or reaction with the nucleophilic water based electrolyte used in the conducting liquid. Lastly, the individual components of the respective conductive and non-conductive liquids are also chemically stable with respect to each other, i.e. they exhibit no or substantially no chemical reactivity in presence of other compounds of the conducting and non-conducting liquids within the functional temperature range of the device.

With regards to the viscosity parameter, a low viscosity may be desired for the non-conductive liquid in some applications since a less viscous liquid is expected to be able to respond to the varying voltages applied through the cell of the liquid lens/electrowetting optical device. An aqueous based conductive layer's viscosity is generally low and it responds quickly to voltage changes. In some embodiments, the viscosity of the non-conductive liquid may be less than 40 cs, less than 20 cs, or less than 10 cs as measured at all temperatures in the range from −20° C. and +70° C.

In some embodiments, the non-conductive liquid having an index of refraction at 546 nm of 1.2909 and an Abbe number of 101.3 may be coupled with the conductive liquid having a second index of refraction of 1.3887 and Abbe Number of 58.568 to form a negative liquid lens or negative optical power electrowetting device. By applying negative voltage across four electrodes to this negative optical power electrowetting device, the liquid interface between the non-conductive and conductive liquids can be changed to create a negative curvature (positive optical power) of +10 diopters or a voltage can be applied to create a positive curvature (negative optical power) up to at least −30 diopters. In some embodiments, the negative optical power electrowetting device may create a positive curvature (negative optical power) up to at least −10 diopters, at least −20 diopters, at least −30 diopters, at least −40 diopters, or at least −50 diopters.

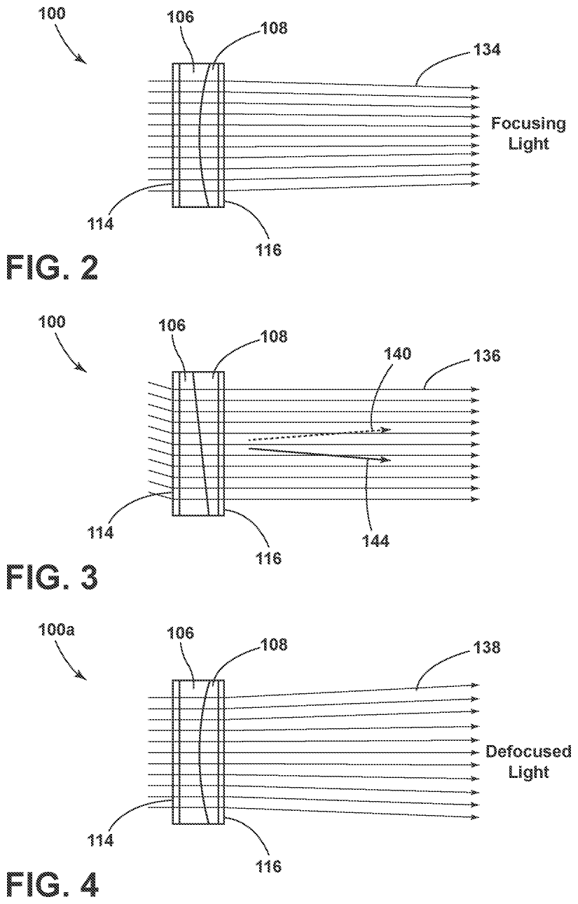

Referring now to FIG. 2, a schematic cross-sectional view of a conventional liquid lens 100 providing a positive optical power is illustrated. Conventional liquid lenses 100 include the first liquid 106 (e.g., polar liquid) and the second liquid 108 (e.g., oil or non-polar liquid) positioned between the top window 114 and the bottom window 116. As light is directed through the top window 114 and projected through the first liquid 106, the second liquid 108, and corresponding interface 110 (see FIG. 1) of the liquid lens 100, the liquid lens 100 creates a positive optical power with increasing voltage as the index of refraction of the second liquid 108 is greater than the second index of refraction of the first liquid 106. Accordingly, the light passing through the liquid lens 100 is focused upon passing through the interface 110 between the first liquid 106 and second liquid 108 as illustrated.

Referring now to FIG. 3, a schematic cross-sectional view of a liquid lens 100 providing a tilt interface according to some embodiments of the present disclosure is illustrated. Similar to the structure provided in FIG. 2, the liquid lens 100 includes the first liquid 106 (e.g., polar liquid) and the second liquid 108 (e.g., oil or non-polar liquid) positioned between the top window 114 and the bottom window 116. FIG. 3 demonstrates embodiments where the liquid lens 100 is moved up and a voltage is applied to tilt the liquid interface 110 (see FIG. 1) to compensate for green light and center the image. Due to dispersion, blue light 140 is not totally compensated for and exits at a slightly positive angle relative to the green light. In addition, due to dispersion, red light 144 is also not totally compensated for and exits at a slightly negative angle relative to the green light. In summary, as light is directed through the top window 114 and projected through the first liquid 106 and the second liquid 108 and corresponding interface 110 of the liquid lens 100, the green light and center image are adjusted for but both the blue light 140 and red light 144 are dispersed as illustrated.

FIG. 4 is a schematic cross-sectional view of a liquid lens providing a negative optical power according to some embodiments of the present disclosure is illustrated. Similar to the structure provided in FIG. 2, the liquid lens 100 includes the first liquid 106 (e.g., polar liquid) and the second liquid 108 (e.g., oil or non-polar liquid) positioned between the top window 114 and the bottom window 116. As light is directed through the top window 114 and projected through the first liquid 106 and the second liquid 108 and corresponding interface 110 (see FIG. 1) of the liquid lens 100, the liquid lens 100 creates a negative optical power with increasing voltage as the index of refraction of the non-conductive liquid is less than the second index of refraction of the conductive liquid. Accordingly, the light passing through the liquid lens 100 is defocused upon passing through the interface 110 between the first liquid 106 and second liquid 108 as illustrated.

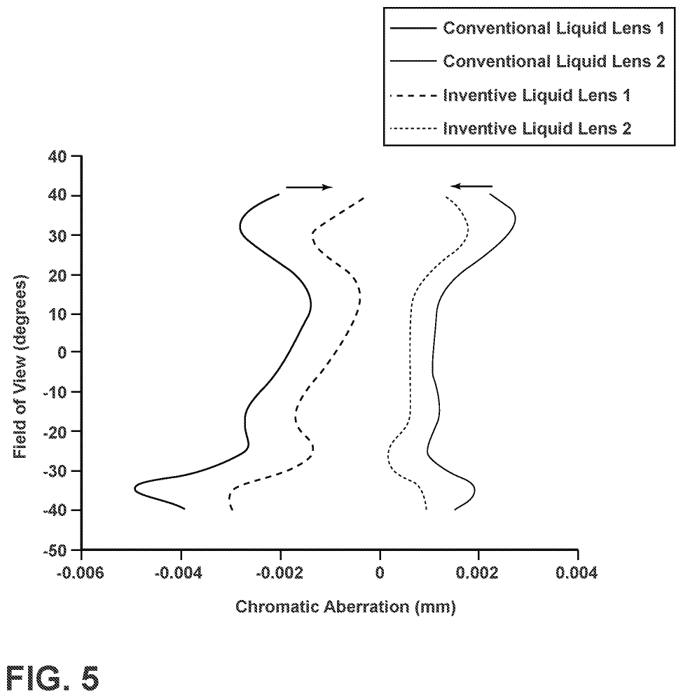

FIG. 5 is a plot of the chromatic aberrations for positive and negative optical power liquid lenses according to some embodiments of the present disclosure. The chromatic aberration, illustrated by the difference in image height separation between blue light and green light using conventional liquids (conventional liquid lens)(solid line location with positive values) and inventive liquids (inventive liquid lens) marked with the dashed line with positive values. Additionally, the difference in image height separation between red light and green light is also reduced when using inventive liquids. This reduced image height separation between wavelengths yields improves (height reduced) by approximately 50% with the use of the low refractive index non-conducting liquid when applying optical image stabilization. The reduced chromatic aberrations enables reduced image blur and improved image quality.

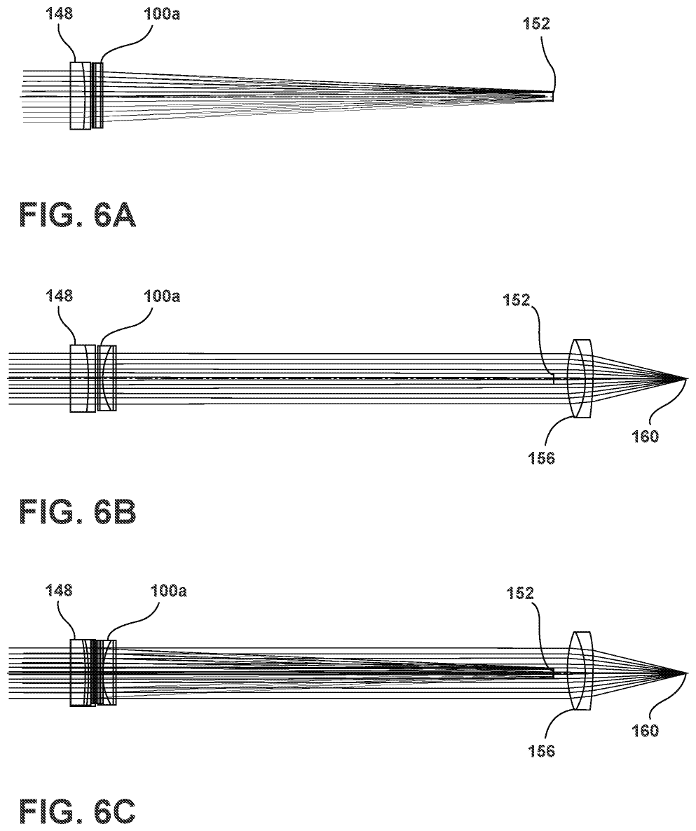

FIGS. 6A-6C are schematic cross-sectional views of a liquid shutter according to some embodiments of the present disclosure. The liquid shutter includes the negative optical power electrowetting optical device 100 having the non-conductive liquid having the refractive index; the conductive liquid having the second refractive index; and the dielectric surface in contact with both the conductive and non-conductive liquids. The liquid shutter additionally includes an objective 148, an imaging lens 156 and a blocking member 152 positioned between the negative optical power electrowetting optical device 100 and the imaging lens 156. The refractive index of the non-conductive liquid is less than the second refractive index of the conductive liquid and the conductive liquid is immiscible with the non-conductive liquid. Referring to FIG. 6A, the liquid shutter is activated and the light rays are blocked by the blocking member 152 when no voltage is applied to the liquid lens 100. For example, the light rays that are blocked by the blocking member 152 can be blocked from being incident on the imaging lens 156 that refocuses the light to project an image 160 on a sensor or other light receiving member. Referring to FIG. 6B, the liquid shutter is deactivated and the light rays are defocused using the negative optical power electrowetting optical device 100 and are refracted to bypass the blocking member 152 and project to the imaging lens 156 that refocuses the light to project an image 160 on a sensor or other light receiving member. Referring to FIG. 6C, both the image of the activated shutter (FIG. 6A) and the image of the deactivated shutter (FIG. 6B) are superimposed to emphasize both lighting configurations demonstrating the use of the blocking member 152 used in combination with the imaging lens 156.

Still referring to FIGS. 6A-6C, because both the conductive liquid and the non-conductive liquid in the liquid lens 100 have relatively low refractive indices and low dispersion, the chromatic aberration introduced is significantly improved compared to conventional liquid lenses using higher refractive index oils. This aspect is particularly important for applications that use the liquid lens 100 for optical image stabilization as it significantly reduces the aberrations introduced during stabilization. Since the non-conductive liquid used in these embodiments have a lower refractive index than the second refractive index of the conductive liquid, the liquid lens 100 operates with negative optical power as voltage is applied. Negative optical power electrowetting optical devices enable new applications where focus beyond infinity (virtual objects) is desired. If negative optical power electrowetting optical devices are able to focus on an object at infinity while voltage is applied (a negative optical power configuration), then the negative optical power electrowetting optical device can operate as an autofocus element by reducing voltage to the liquid lens to focus at shorter object distances. If coupled with auxiliary optics such as the objective 148 and imaging lens 156 illustrated in FIGS. 6A-6C, the negative power liquid lens 100 can also operate as a high efficiency liquid shutter. Such high efficiency liquid shutters are of special value due to the longevity of the shutter since there are no mechanical parts. In addition, the switching rates for these liquid shutters can be on the millisecond time scale or extremely fast. In some embodiments, the liquid shutter has a switching time less than 25 msec, less than 20 msec, less than 15 msec, less than 10 msec, or less than 5 msec. The design of the negative optical power electrowetting optical device may require minimal current and corresponding power to drive the negative power electrowetting optical device; hence, power consumption can be relatively low over the life of the electrowetting optical device.

According to some embodiments, the electrowetting optical device includes a voltage source for applying an A.C. voltage to vary the meniscus formed between the conductive and non-conductive liquids to control the focal length of the lens. In some embodiments, the electrowetting optical device further includes a driver or similar electronic device for controlling the lens where the lens and driver or similar electronic device are integrated into the liquid lens. In other embodiments, the electrowetting optical device may include a plurality of lenses incorporating at least one driver or similar electronic device.

The electrowetting optical device may be used as or be part of a variable focal length liquid lens, an optical zoom, an ophthalmic device, a device having a variable tilt of the optical axis, an image stabilization device, a light beam deflection device, a variable illumination device, and any other optical device using electrowetting. In some embodiments, the liquid lens/electrowetting optical device may be incorporated or installed in any one or more apparatuses including, for example, a camera lens, a cell phone display, an endoscope, a telemeter, a dental camera, a barcode reader, a beam deflector, and/or a microscope.

In some embodiments, the negative power electrowetting optical device may be used in a front facing camera. In front facing camera applications using a negative power electrowetting optical device, a low optical power configuration may be used for close up (arm's length away) distances while a higher negative optical power may be desired at longer distances such at selfie stick distances. Power configurations using low optical power at closer distances and higher optical power at longer distances may be obtained using negative power electrowetting optical devices. In addition, such negative power electrowetting optical device may enable lower or reduced chromatic aberrations. In other embodiments, the negative power electrowetting optical device may be used is switching applications including, but not limited to, fiber optics, fiber optical telecommunication, electrooptical switches or switching, optical logic memory, optical interconnects, sensors, optical waveguide and waveguide array interfaces, embedded optical interfaces, and the like.

### EXAMPLES

The following table provides a variety of different non-conductive liquids having a variety of different ranges in viscosity, density, and refractive index. In some embodiments, the non-conductive liquids may be mixed and blended together to meet the specifications and desired properties of the negative optical power electrowetting device. As currently known and practiced, none of these non-conductive liquid components are utilized or would be used in a positive optical power liquid lens design because of their low refractive indices. Although some compounds such as acetonitrile could be selected to give a low refractive index of 1.3405, a variety of other important physical properties such as miscibility, viscosity, and density must be balanced in order to provide a functional negative optical power electrowetting device. In the embodiments disclosed herein, the non-conductive liquid (oil) of the negative optical power electrowetting device may be hydrophobic enough to phase separate from the conductive liquid while maintaining the refractive index below 1.40. Examples of non-conductive liquids that may be used alone or in any combination as described herein are provided in Table 1.

TABLE 1

| | | | Viscosity |
|---|---|---|---|
| | Refractive | Density | at 25° C. |
| Example | index | (g/cm³) | (mm²/s or cST) |
| Rhodorsil ® Oil 41 V 0.65 | 1.375 | 0.760 | 0.65 |
| Rhodorsil ® Oil 47 V 3 | 1.395 | 0.890 | 3 |
| Rhodorsil ® Oil 47 V5 | 1.397 | 0.910 | 5 |
| Rhodorsil ® Oil 47 V 20 | 1.400 | 0.950 | 20 |
| Galden ® PFPE HT55 | 1.280 | 1.65 | 0.45 |
| Galden ® PFPE HT70 | 1.280 | 1.68 | 0.50 |
| Galden ® PFPE HT80 | 1.280 | 1.69 | 0.57 |
| Galden ® PFPE HT110 | 1.280 | 1.71 | 0.77 |
| Galden ® PFPE HT135 | 1.280 | 1.72 | 1.00 |
| Galden ® PFPE HT170 | 1.280 | 1.77 | 1.80 |
| Galden ® PFPE HT200 | 1.280 | 1.79 | 2.40 |
| Galden ® PFPE HT230 | 1.280 | 1.82 | 4.40 |
| Galden ® PFPE HT270 | 1.280 | 1.85 | 14.00 |
| Fluorinert ™ FC-40 | 1.290 | 1.91 | 2.2 |
| Fluorinert ™ FC-77 | 1.280 | 1.77 | 0.71 |
| Trichloro(1H,1H,2H,2H- | 1.352 | 1.30 | NA |
| perfluorooctyl)silane | | | |
| (CAS 78560-45-9) | | | |
| Dynasylan ® 6490 | NA | 1.00 | 2-4 |
| C6H14 (Hexane) | 1.3741 | 0.6548 | 0.376 |
| C7H16 (Heptane) | 1.3873 | 0.6795 | 0.386 |
| C7H16 (Heptane) | 1.3876 | 0.6838 | 0.376 |
| 1H,1H,2H,2H- | 1.344 | 1.3299 | 3.5 |
| Perfluorodecyltrimethoxysilane | | | |
| Perfluorodecalin (C10F18) | 1.3145 | 1.917 | 2.63 |

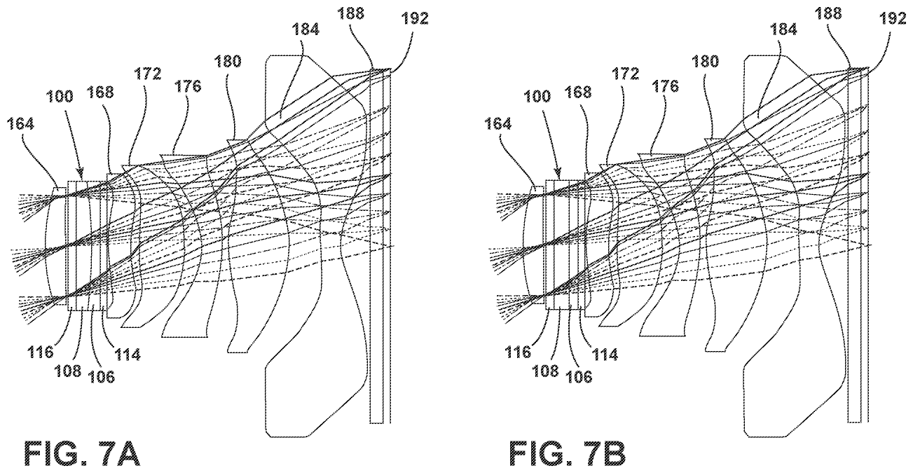

Referring now to FIGS. 7A-7B, a schematic cross-sectional view of a liquid lens 100 positioned in a mobile phone camera module is illustrated. Referring to FIG. 7A, the liquid lens 100 and corresponding optics are designed such that an object at infinity is focused when a driving voltage is applied to the liquid lens 100 where the refractive index of the non-conductive liquid is less than the second refractive index of the conductive liquid and wherein the conductive liquid is immiscible with the non-conductive liquid. Similar to the structure previously provided, the liquid lens 100 include the first liquid 106 (e.g., polar liquid) and the second liquid 108 (e.g., oil or non-polar liquid) positioned between the top window 114 and the bottom window 116. As light is directed through the top window 114 and projected through the first liquid 106 and the second liquid 108 and corresponding interface 110 of the liquid lens 100, the liquid lens 100 creates a negative optical power with increasing voltage as the index of refraction of the non-conductive liquid is less than the second index of refraction of the conductive liquid. In some embodiments, the liquid lens 100 may be included in the camera module described in FIGS. 7A and 7B where the liquid lens 100 or negative optical power electrowetting optical device may be varied as described herein.

Still referring to FIGS. 7A-7B, the optics surrounding the negative power liquid lens 100 include a first fixed optical lens 164, a second fixed optical lens 168, a third fixed optical lens 172, a fourth fixed optical lens 176, a fifth fixed optical lens 180, a sixth fixed optical lens 184, a spectral filter 188, and a camera sensor 192. The liquid lens 100 includes the first liquid 106 and the second liquid 108 positioned between the top window 114 and the bottom window 116. Referring to FIG. 7B, the structure of the liquid lens 100 positioned in the mobile phone camera module and corresponding optics is the same as described for FIG. 7A. In FIG. 7B, the voltage is reduced to the liquid lens 100 to implement autofocus for objects as various distances less than infinity such as an object positioned at 10 cm.

Still referring to FIGS. 7A-7B, optical design description for the simulated use of the negative optical power electrowetting device positioned inside the camera module optical system with an 80° field of view and aperture of F/1.9 are summarized in Table 2 provided below:

TABLE 2

| Surface Number | Radius | Thickness | Glass Refracting Index |
|---|---|---|---|
| OBJECT | INFINITY | INFINITY | |
| 1: | 3.05089 | 0.327851 | 1.546 |
| 2: | 87.08640 | 0.023537 | |
| STOP | INFINITY | 0.000000 | |
| 4: | INFINITY | 0.125000 | 1.525 |
| 5: | INFINITY | 0.230000 | 1.2909:101.3 |
| 6: | −12.00000 | 0.150000 | 1.389:58.57 |
| 7: | INFINITY | 0.100000 | 1.525 |
| 8: | INFINITY | 0.02000 | |
| 9: | 2.87655 | 0.346054 | 1.546 |
| 10: | 2.27905 | 0.132495 | |
| 11: | −4.37484 | 0.695409 | 1.546 |
| 12: | −3.72145 | 0.291455 | |
| 13: | −1.26028 | 0.302801 | 1.649 |
| 14: | −3.40920 | 0.100000 | |
| 15: | 2.70936 | 0.934360 | 1.546 |
| 16: | −1.79567 | 0.487366 | |
| 17: | −2.98395 | 0.300000 | 1.546 |
| 18: | 0.89690 | 0.456602 | |
| 19: | INFINITY | 0.210000 | 1.519 |
| 20: | INFINITY | 0.150000 | |
| IMG: | INFINITY | −0.038492 | |

The Forbes polynomial descriptions for Surfaces 1-2 and Surfaces 9-18 as defined by the respective surfaces of the camera module, the first fixed optical lens 164, the second fixed optical lens 168, the third fixed optical lens 172, the fourth fixed optical lens 176, the fifth fixed optical lens 180, the sixth fixed optical lens 184, and the spectral filter 188 which are provided, in part, in Tables 3-14, respectively below:

TABLE 3
Surface #1
Forbes QCon Polynomial

| | |
|---|---|
| K: | −8.9590E+00 |
| NRADIUS: | 1.0538E+00 |
| QC4: | −2.9957E−03 |
| QC6: | −9.9354E−03 |
| QC8: | −2.2026E−03 |
| QC10: | −4.8609E−04 |
| QC12: | −1.0059E−04 |
| QC14: | −3.0944E−05 |

TABLE 4
Surface #2
Forbes QBfs Polynomial

| | |
|---|---|
| NRADIUS: | 8.6278E−01 |
| QB4: | 3.2330E−02 |
| QB6: | −4.1194E−03 |
| QB8: | 9.9664E−04 |
| QB10: | −2.6914E−05 |
| QB12: | −1.1914E−05 |
| QB14: | −1.1617E−06 |
| QB16: | −8.5001E−06 |
| QB18: | −2.8196E−06 |
| QB20: | −2.7454E−05 |

TABLE 5
Surface #9
Forbes QCon Polynomial

| | |
|---|---|
| K: | −2.4937E+00 |
| NRADIUS: | 1.0000E+00 |
| QC4: | −1.0738E−01 |
| QC6: | −8.7926E−03 |
| QC8: | −3.3899E−03 |
| QC10: | −5.2200E−04 |
| QC12: | −1.9136E−04 |
| QC14: | −1.0224E−05 |

TABLE 6
Surface #10
Forbes QCon Polynomial

| | |
|---|---|
| K: | −5.9510E−01 |
| NRADIUS: | 1.1700E+00 |
| QC4: | −3.6717E−01 |
| QC6: | −2.7765E−02 |
| QC8: | −3.8870E−03 |
| QC10 | 1.8071E−03 |
| QC12: | 1.7914E−04 |
| QC14: | 3.6489E−05 |

TABLE 7
Surface #11
Forbes QBfs Polynomial

| | |
|---|---|
| NRADIUS: | 1.2200E+00 |
| QB4: | 4.0327E−01 |
| QB6: | 9.6313E−03 |
| QB8: | −4.1314E−02 |
| QB10: | 1.6662E−02 |
| QB12: | −7.2459E−04 |
| QB14: | −1.2212E−03 |
| QB16: | 3.3942E−04 |
| QB18: | −4.7969E−06 |
| QB20: | 5.5338E−08 |

TABLE 8
Surface #12
Forbes QCon Polynomial

| | |
|---|---|
| K: | 2.4642E+00 |
| NRADIUS: | 1.3758E+00 |
| QC4: | −3.6817E−01 |
| QC6: | −3.2180E−02 |
| QC8: | 4.0081E−03 |
| QC10: | −2.0523E−03 |
| QC12: | −4.0253E−04 |
| QC14: | 2.7071E−04 |

TABLE 9
Surface #13
Forbes QCon Polynomial

| | |
|---|---|
| K: | −1.3476E+00 |
| NRADIUS: | 1.2296E+00 |
| QC4: | 3.1404E−02 |
| QC6: | −1.2563E−02 |
| QC8: | 1.4688E−02 |
| QC10: | −2.4102E−03 |
| QC12: | 1.9404E−04 |
| QC14: | −4.2552E−05 |

TABLE 10
Surface #14
Forbes QCon Polynomial

| | |
|---|---|
| K: | −5.3817E−01 |
| NRADIUS: | 1.4438E+00 |
| QC4: | 4.6063E−02 |
| QC6: | 1.6941E−02 |
| QC8: | 1.2394E−02 |
| QC10: | −4.4697E−03 |
| QC12: | 1.1143E−03 |
| QC14: | −3.7372E−04 |

TABLE 11
Surface #15
Forbes QCon Polynomial

| | |
|---|---|
| K: | −1.2604E+00 |
| NRADIUS: | 1.6797E+00 |
| QC4: | −4.8716E−01 |
| QC6: | −1.2370E−03 |
| QC8: | −4.1574E−03 |
| QC10: | 1.7776E−03 |
| QC12: | 1.2753E−03 |
| QC14: | 5.7766E−04 |

TABLE 12
Surface #16
Forbes QCon Polynomial

| | |
|---|---|
| K: | −6.8132E+00 |
| NRADIUS: | 1.9169E+00 |
| QC4: | −1.3469E−01 |
| QC6: | 6.9395E−02 |
| QC8: | 8.8712E−02 |
| QC10: | 5.1938E−02 |
| QC12: | 2.3439E−02 |
| QC14: | 7.3523E−03 |

TABLE 13
Surface #17
Forbes QBfs Polynomial

| | |
|---|---|
| NRADIUS: | 2.1000E+00 |
| QB4: | −3.2881E−01 |
| QB6: | 3.6771E−01 |
| QB8: | 5.3463E−02 |
| QB10: | 2.4108E−02 |
| QB12: | 4.7958E−02 |
| QB14: | −1.6350E−02 |
| QB16: | −5.6460E−03 |
| QB18: | 7.5941E−03 |
| QB20: | 3.2587E−03 |
| QB22: | 6.4749E−04 |
| QB24: | 2.8236E−04 |
| QB26: | 1.3530E−03 |
| QB28: | −1.0251E−03 |
| QB30: | 9.7529E−04 |

TABLE 14
Surface #18
Forbes QCon Polynomial

| | |
|---|---|
| K: | −4.7989E+00 |
| NRADIUS: | 2.8500E+00 |
| QC4: | −1.2105E+00 |
| QC6: | 1.3746E−01 |
| QC8: | −1.1987E−01 |
| QC10: | 9.8796E−03 |
| QC12: | −1.2314E−02 |
| QC14: | −6.0039E−03 |

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A negative optical power electrowetting optical device comprising:
a non-conductive liquid having a refractive index;
a conductive liquid having a second refractive index; and
a dielectric surface in contact with both the conductive and non-conductive liquids,
wherein the refractive index of the non-conductive liquid is less than the second refractive index of the conductive liquid and wherein an interface between the conductive liquid and the non-conductive liquid forms a lens; and
wherein the non-conductive liquid comprises an alkyl group having from 5 to about 40 carbon atoms, a fluorinated alkyl group having from 5 to about 40 carbon atoms, a silicone oil, a fluorinated silicone oil, a silane, a fluorinated silane, a perfluoropolyether, a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof.

2. (canceled)

3. The electrowetting optical device according to claim 1, wherein the non-conductive liquid comprises a silicone oil compound having Formula (I) and/or a fluorinated silicone oil compound having Formula (II): 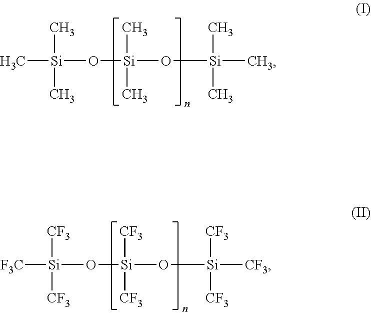
wherein n is 0 or an integer greater than 0.

4. The electrowetting optical device according to claim 1, wherein the non-conductive liquid comprises a perfluoropolyether compound having Formula (III): 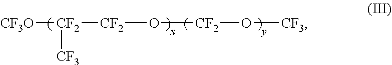
wherein x and y are individually an integer greater than 0.

5. The electrowetting optical device according to claim 1, wherein the non-conductive liquid comprises a fluorinated silane compound having Formula (IV):

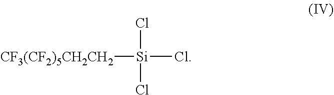

6. The electrowetting optical device according to claim 1, wherein the refractive index of the non-conductive liquid is less than 1.40.

7. The electrowetting optical device according to claim 1, wherein the refractive index of the non-conductive liquid is at least 0.08 less than the second refractive index of the conductive liquid.

8. The electrowetting optical device according to claim 1, wherein the non-conductive liquid has a density at 20° C. from 1.00 g/cm³ to 1.10 g/cm³.

9. The electrowetting optical device according to claim 1, wherein the non-conductive liquid has viscosity at 20° C. from about 2 cs to about 10 cs.

10. A camera module comprising the electrowetting optical device according to claim 1.

11. A liquid shutter comprising:
a negative optical power electrowetting optical device comprising:
a non-conductive liquid having a refractive index;
a conductive liquid having a second refractive index; and
a dielectric surface in contact with both the conductive and non-conductive liquids,
an imaging lens; and
a blocking member positioned between the negative optical power electrowetting optical device and the imaging lens,
wherein the refractive index of the non-conductive liquid is less than the second refractive index of the conductive liquid and wherein an interface between the conductive liquid and the non-conductive liquid forms a lens.

12. The liquid shutter according to claim 11, wherein the liquid shutter has a switching time less than 10 msec.

13. The liquid shutter according to claim 11, wherein the non-conductive liquid comprises an alkyl group having from 5 to about 40 carbon atoms, a fluorinated alkyl group having from 5 to about 40 carbon atoms, a silicone oil, a fluorinated silicone oil, a silane, a fluorinated silane, a perfluoropolyether, a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof.

14. The liquid shutter according to claim 11, wherein the refractive index of the non-conductive liquid is less than 1.40.

15. The liquid shutter according to claim 11, wherein the refractive index of the non-conductive liquid is at least 0.08 less than the second refractive index of the conductive liquid.

16. A negative optical power liquid system comprising:
a non-conductive liquid having a refractive index; and
a conductive liquid having a second refractive index,
wherein the refractive index of the non-conductive liquid is less than the second refractive index of the conductive liquid and wherein the conductive liquid is immiscible with the non-conductive liquid; and
wherein the non-conductive liquid comprises an alkyl group having from 5 to about 40 carbon atoms, a fluorinated alkyl group having from 5 to about 40 carbon atoms, a silicone oil, a fluorinated silicone oil, a silane, a fluorinated silane, a perfluoropolyether, a siloxane, a fluorinated siloxane, a fluoropolymer, a polytetrafluoroethylene (PTFE), a polyvinyl fluoride (PVF), a fluorinated ethylene propylene (FEP), a perfluoroalkoxy (PFA), a perfluoromethylvinyl ether, a perfluorinated fluoroelastomer, or a combination thereof.

17. (canceled)

18. The negative optical power liquid system according to claim 16, wherein the non-conductive liquid comprises a perfluoropolyether compound having Formula (II): 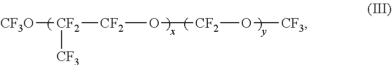
wherein x and y are individually an integer greater than 0.

19. The negative optical power liquid system according to claim 16, wherein the refractive index of the non-conductive liquid is less than 1.40.

20. The negative optical power liquid system according to claim 16, wherein the refractive index of the non-conductive liquid is at least 0.08 less than the second refractive index of the conductive liquid.

21. The liquid shutter according to claim 11, wherein:
in an activated state, light rays focused by the electrowetting optical device are blocked by the blocking member from being incident on the imaging lens; and
in a deactivated state, light rays defocused by the electrowetting optical device bypass the blocking member and project to the imaging lens, which refocuses the light rays to project an image on a sensor.

22. The liquid shutter according to claim 21, wherein the liquid shutter is in the activated state when no voltage is applied to the electrowetting optical device.
